(19) United States
(12) Patent Application Publication
(10) Pub. No.: US 2020/0089402 A1
(43) Pub. Date: Mar. 19, 2020

(54) PROVIDING ONE OR MORE NEW VIRTUAL KEYS IN A VIRTUAL KEYBOARD THAT EACH CORRESPOND TO A PREDICTED SET OF CHARACTERS

(71) Applicant: CA, Inc., New York, NY (US)

(72) Inventors: Balram Reddy Kakani, Hyderabad (IN); STV Krishna Kanth, Hyderabad (IN); Vallinayagam Pitchaimani, Chennai (IN); Sri Harsha Yayi, Hyderabad (IN); Nageswara Rao Yeluri, Hyderabad (IN)

(73) Assignee: CA, Inc., New York, NY (US)

(21) Appl. No.: 16/132,627

(22) Filed: Sep. 17, 2018

(51) Int. Cl. G06F 3/0488; G06F 17/27; G06F 17/22; G06F 3/0482; G06F 3/041; G06F 3/0486

(52) U.S. Cl. CPC G06F 3/04886; G06F 17/277; G06F 3/0486; G06F 3/0482; G06F 3/0414; G06F 17/22

(57) ABSTRACT

A method of operating an electronic device is provided. The method includes displaying a virtual keyboard including a plurality of virtual keys each corresponding to one character of a plurality of characters. The method further includes receiving a first input of one or more characters in a sequential order, and generating one or more predicted sets of characters based on the first input, wherein each predicted set of characters includes a last character of the sequential order and a subsequent character generated by a processing circuit. The method also includes displaying each of the predicted sets of characters in a portion of the touchscreen different from the virtual keyboard. The method further includes displaying one or more new virtual keys that each correspond to one of the predicted sets of characters in the virtual keyboard, wherein each of the new virtual keys has a location based on the first input.

### TECHNICAL FIELD

The present disclosure relates generally to input methods for electronic devices and, more particularly, to providing one or more new virtual keys in a virtual keyboard that each correspond to a predicted set of characters.

### BACKGROUND

Advances in technology have recently led to electronic devices, such as computers, tablets, and cellular phones, being able to process text input increasingly quickly and on increasingly smaller devices and keyboards. However, decreasing the size of a keyboard can result in slower and/or less accurate input of text. Therefore, to increase the accuracy with which a user can input text, some electronic devices have begun to provide predicted words to the user during the input process. For example, after inputting the characters “h” and “o,” an electronic device may display the words “home,” “hold,” and/or “hope” above the keyboard so that a user may select one of the displayed words. In this manner, the probability of further typographical errors may be decreased.

However, by only making the predicted words selectable in a portion of the touchscreen above the keyboard, selecting the predicted words may be non-intuitive and/or difficult for some users when typing at high speeds. Accordingly, there is a need for more efficient ways of entering text into electronic devices.

### SUMMARY

Some embodiments disclosed herein are directed to providing one or more new virtual keys in a virtual keyboard that each correspond to a predicted set of characters. Some electronic devices may provide predicted words to a user during the input process to increase the accuracy with which the user can input text. However, the location for selecting the predicted words on the touchscreen of the electronic device may be non-intuitive and/or difficult for some users to reach when typing at high speeds.

Thus, in embodiments disclosed herein, a method of operating an electronic device is provided. In some embodiments, the electronic device includes a processing circuit, an interface connected to the processing circuit, and a touchscreen connected to the interface. The method of operating the electronic device includes displaying, on the touchscreen, a virtual keyboard including multiple virtual keys. Each of the virtual keys corresponds to one character of multiple characters. The method further includes receiving, via the interface and from a user, a first input of one or more of the multiple characters in a sequential order. The method also includes generating one or more predicted sets of characters based on the first input. In some embodiments, each of the one or more predicted sets of characters includes a last character of the sequential order of the one or more of the multiple characters of the first input and a subsequent character generated by the processing circuit. The method of operating the electronic device also includes displaying, on the touchscreen, each of the one or more predicted sets of characters in a portion of the touchscreen that is different from the virtual keyboard. The method further includes displaying, on the touchscreen, one or more new virtual keys that each correspond to one of the one or more predicted sets of characters in the virtual keyboard. In some embodiments, each of the one or more new virtual keys that each correspond to one of the one or more predicted sets of characters has a location that is based on the first input.

Some other related embodiments disclosed herein are directed to a computer program product including a tangible, non-transitory computer-readable storage medium including computer-readable program code that is executable by a processor to perform a method. In some embodiments, the method includes displaying, on a touchscreen of an electronic device, a virtual keyboard comprising multiple virtual keys. Each of the multiple virtual keys corresponds to one character of multiple characters. The method further includes receiving, via an interface of the electronic device and from a user, a first input of one or more of the multiple characters in a sequential order. The method also includes generating one or more predicted sets of characters based on the first input. In some embodiments, each of the one or more predicted sets of characters includes a last character of the sequential order of the one or more of the multiple characters of the first input and a subsequent character generated by a processing circuit of the electronic device. The method also includes displaying, on the touchscreen, each of the one or more predicted sets of characters in a portion of the touchscreen that is different from the virtual keyboard. The method further includes displaying, on the touchscreen, one or more new virtual keys that each correspond to one of the one or more predicted sets of characters in the virtual keyboard. In some embodiments, each of the one or more new virtual keys that each correspond to one of the one or more predicted sets of characters has a location that is based on the first input.

It is noted that aspects described with respect to one embodiment disclosed herein may be incorporated in different embodiments although not specifically described relative thereto. That is, all embodiments and/or features of any embodiments can be combined in any way and/or combination. Moreover, methods, systems, and/or computer program products according to embodiments will be or become apparent to one with skill in the art upon review of the following drawings and detailed description. It is intended that all such additional methods, systems, and/or computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 illustrates a conventional electronic device displaying, on a touchscreen, a virtual keyboard and predicted words that are selectable only in a portion of the touchscreen above the virtual keyboard;

FIG. 2 illustrates an electronic device including one or more new virtual keys in a virtual keyboard that each correspond to a predicted set of characters, and are substantially adjacent a virtual key corresponding to a last character of a first input, according to some embodiments;

FIG. 3 illustrates a flowchart of operations performed by the electronic device of FIG. 2;

FIG. 4 illustrates an electronic device including one or more new virtual keys in a virtual keyboard that each correspond to a predicted set of characters, and are each substantially adjacent a virtual key corresponding to a respective subsequent character generated by a processing circuit of the electronic device, according to some embodiments; and

FIG. 5 illustrates a block diagram of an electronic device including a processing circuit, an interface, and a memory storing instructions for providing one or more new virtual keys in a virtual keyboard that each correspond to a predicted set of characters, according to some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment. Like numbers refer to like elements throughout.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As discussed above, some electronic devices may provide predicted words to a user during the input process to increase the accuracy with which the user can input text. However, the location for selecting the predicted words on the touchscreen of the electronic device may be non-intuitive and/or difficult for some users to reach when typing at high speeds. Thus, in embodiments disclosed herein, a method of operating an electronic device is provided. In some embodiments, the electronic device includes a processing circuit, an interface connected to the processing circuit, and a touchscreen connected to the interface. The method includes displaying, on the touchscreen, a virtual keyboard including multiple virtual keys, where each of the virtual keys corresponds to a character. The method further includes receiving, via the interface and from a user, a first input of one or more characters in a sequential order. The method also includes generating one or more predicted sets of characters based on the first input. In some embodiments, each of the predicted sets of characters includes a last character of the first input and a subsequent character generated by the processing circuit. The method also includes displaying, on the touchscreen, each of the predicted sets of characters in a portion of the touchscreen that is different from the virtual keyboard. The method further includes displaying, on the touchscreen, one or more new virtual keys that each correspond to one of the predicted sets of characters in the virtual keyboard. In some embodiments, each of the new virtual keys has a location that is based on the first input.

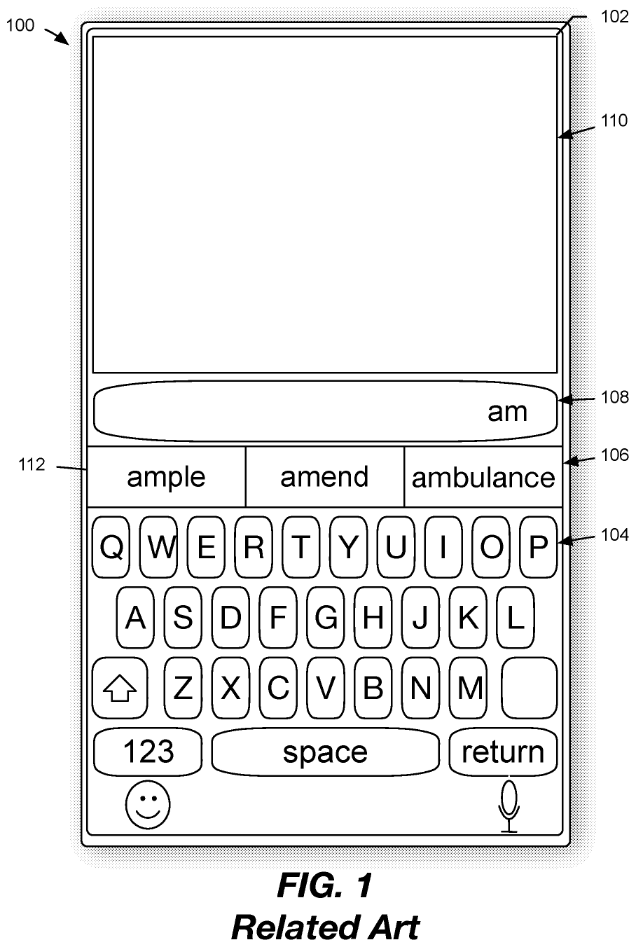

As noted in the background, some conventional electronic devices provide predicted words to a user on a touchscreen during the input process to increase the accuracy with which the user can input text. However, in such conventional electronic devices, the display and selection of the predicted words may be non-intuitive and/or difficult for some users, resulting in slower typing speeds and a poor user experience. In this regard, FIG. 1 illustrates an example of a conventional electronic device 100. As shown, the conventional electronic device 100 includes a touchscreen 102. The touchscreen 102 includes a virtual keyboard 104, a portion 106 of the touchscreen 102 above the virtual keyboard 104 for displaying predicted words, an input field 108, and a display region 110.

During operation of the conventional electronic device 100, a user may input a number of characters in a sequence by selecting one or more of the keys of the virtual keyboard 104. For example, with regard to FIG. 1, a user may select the letters “a” and then “m,” as shown in the input field 108. Based on the sequence “am,” the conventional electronic device 100 may determine that the user intends to type a particular set of characters or a particular word. As illustrated in the example in FIG. 1, the conventional electronic device 100 may generate predicted sets of characters that include “ample,” “amend,” and “ambulance” based on the sequence “am.” Once determined, the electronic device 100 may display the predicted sets of characters in a portion 106 of the touchscreen 102 above the virtual keyboard 104 so that the user may select one of the words by pressing the area within which the desired word is displayed. For example, the user may select the word “ample” by pressing the area 112 that is in the portion 106 above the virtual keyboard 104. In this manner, the word “ample” may be inputted into the input field 108 so that it may later be used or entered by the user.

However, by making the word “ample” selectable only in the area 112 that is in the portion 106 above the virtual keyboard 104, the user must move his or her finger from the “m” key to the area 112 to select the predicted word. While this type of distance may appear only minorly inconvenient during a single selection, it may be much more inconvenient, non-intuitive, and therefore slow, during the course of typing an entire sentence or paragraph. Further, since indications of the predicted words only occur above the virtual keyboard 104, the user may not even recognize that a predicted word has been generated because the user's eyes may be focused within the virtual keyboard 104 during operation. Thus, embodiments disclosed herein are directed to providing one or more new virtual keys in a virtual keyboard that each correspond to a predicted set of characters, thereby increasing both the speed and accuracy with which a user can input text into an electronic device.

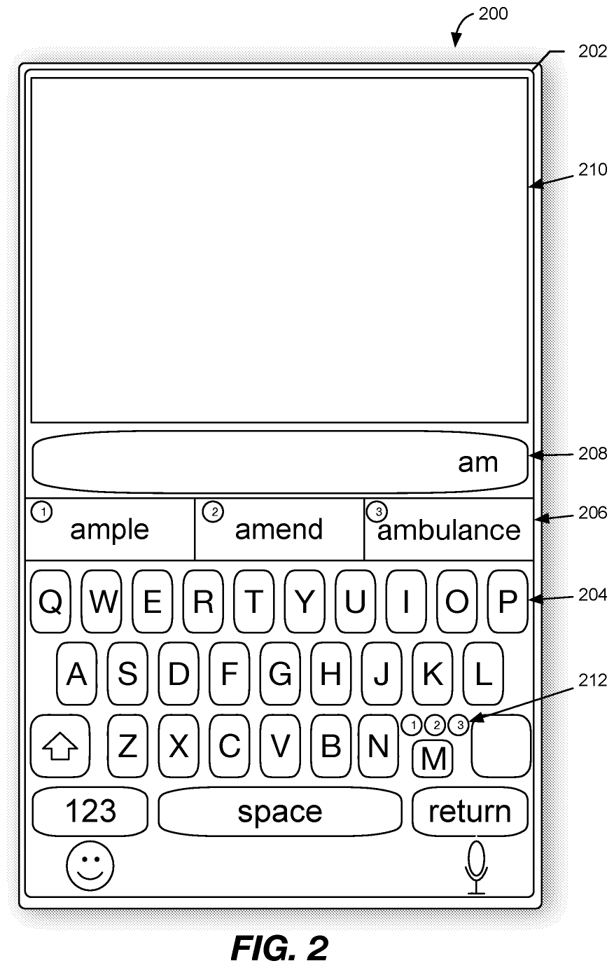

In this regard, FIG. 2 illustrates an electronic device 200 according to some examples. Although not all shown in FIG. 2, the electronic device 200 includes a processing circuit, an interface connected to the processing circuit, and a touchscreen 202 connected to the interface. Similar to the conventional electronic device 100 illustrated in FIG. 1, the electronic device 200 includes a virtual keyboard 204, a portion 206 of the touchscreen 202 above the virtual keyboard 204, an input field 208, and a display region 210. In contrast to the conventional electronic device 100, the electronic device 200 includes one or more new virtual keys 212 (“1,” “2,” and “3”) in the virtual keyboard 204 that each correspond to a predicted set of characters (i.e., “ample,” “amend,” and “ambulance”). As explained in further detail below, in some embodiments, the one or more new virtual keys 212 are substantially adjacent a virtual key corresponding to a last character of a first input. In this example, the “1,” “2,” and “3” keys are the new virtual keys 212 that are each adjacent to the virtual “m” key, which is the last character of the first input “am.”

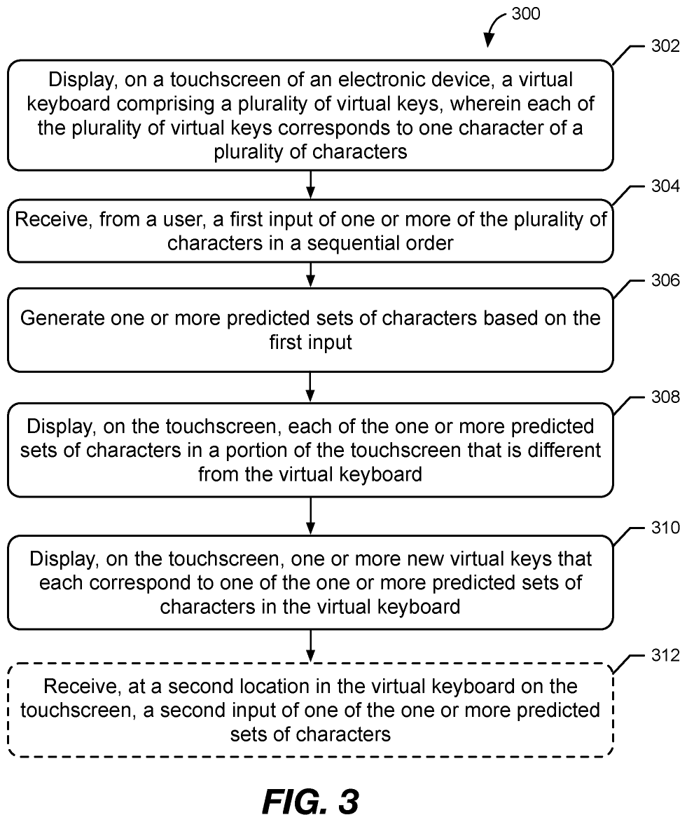

FIG. 3 illustrates a flowchart 300 of operations of a method of operating the electronic device 200 illustrated in FIG. 2 to provide the one or more new virtual keys 212 in the virtual keyboard 204 according to some examples. Thus, as shown in FIG. 3, the method includes displaying, on the touchscreen 202 of the electronic device 200, the virtual keyboard 204 comprising multiple virtual keys, wherein each of the virtual keys corresponds to one character of multiple characters (block 302). As illustrated in FIG. 2, the virtual keyboard 204 displayed by the electronic device 200 includes a virtual key for each letter of the English alphabet, as well as keys for capitalization, deleting, accessing multiple secondary virtual keys (‘123’), a space key, a return key, an emoji key for accessing emojis, and a key for activating a microphone of the electronic device 200. In additional embodiments, virtual keys may be displayed in a variety of shapes, sizes, colors, and other possible attributes, and may correspond to individual characters, sets of characters, and/or functions. Further, such virtual keys may be provided for any other alphabet of any other language, such as Arabic, Korean, Japanese, Chinese, Cyrillic, and so forth.

The method of the flowchart 300 further includes receiving, from a user, a first input of one or more of the multiple characters in a sequential order (block 304). In the example illustrated in FIG. 2, the first input includes the characters “a” and “m” in the sequential order “am,” as noted above and shown in the input field 208. While this example only shows the characters “a” and “m,” the characters of the first input may include any number characters in any combination. Further, the letters may be received via typing, speaking through a microphone of the electronic device 200, via drawing on a pad of the touchscreen, via a camera attached to the electronic device 200, or by another other suitable means of receiving an input.

The method in the flowchart 300 also includes generating one or more predicted sets of characters based on the first input (block 306). In some embodiments, each of the one or more predicted sets of characters includes a last character of the sequential order of the one or more of the multiple characters of the first input. In this example, the predicted sets of characters “ample,” “amend,” and “ambulance” include the last character “m” of the first input “am.” Further, in some embodiments, each of the one or more predicted sets of characters includes a subsequent character generated by the processing circuit of the electronic device 200. In this example, the subsequent character for “ample” is the character “p,” the subsequent character for “amend” is the character “e,” and the subsequent character for “ambulance” is the character “b.” In some embodiments, each of the one or more predicted sets of characters is a word, such as “ample,” containing one of the one or more of the multiple characters of the first input, such as “am.” In yet additional embodiments, some of the predicted sets of characters may further include emojis, punctuation marks, and/or other relevant symbols that are related to the first input.

In some embodiments, the method in flowchart 300 includes displaying, on the touchscreen 202, each of the one or more predicted sets of characters in the portion 206 of the touchscreen 202 that is different from the virtual keyboard 204 (block 308). In the example illustrated in FIG. 2, the predicted sets of characters “ample,” “amend,” and “ambulance” are displayed in the portion 206 of the touchscreen 202 above the virtual keyboard 204. In some embodiments, each of the predicted sets of characters displayed in the portion 206 of the touchscreen 202 above the virtual keyboard 204 are selectable by the user. In yet other embodiments, a respective symbol is included adjacent each of the one or more predicted sets of characters in the portion of the touchscreen 202 that is different from the virtual keyboard 204, as discussed in further detail below.

The method in flowchart 300 further includes displaying, on the touchscreen 202, the one or more new virtual keys 212 that each correspond to one of the one or more predicted sets of characters in the virtual keyboard 204 (block 310). In this example, the new virtual keys 212 identified by the characters “1,” “2,” and “3” are displayed on the touchscreen 202 and in the virtual keyboard 204. By including respective symbols “1,” “2,” and “3” next to each of the predicted words “ample,” “amend,” and “ambulance” displayed in the portion 206 of the touchscreen 202 that is different from the virtual keyboard 204, each of the new virtual keys 212 is shown as corresponding to one of the predicted sets of characters. For example, by having the symbol “1” next to the predicted word “ample” in the portion 206 of the touchscreen 202 that is above the virtual keyboard 204, the new virtual key 212 in the virtual keyboard 204 identified by the character “1” is shown as corresponding to the predicted word “ample.” In this regard, a user may select the new virtual key 212 in the virtual keyboard 204 identified by the character “1” in order to input and/or select the predicted word “ample.”

In some embodiments, each of the one or more new virtual keys 212 that correspond to one of the one or more predicted sets of characters has a location that is based on the first input. In embodiments, the location of each of the one or more new virtual keys 212 that each correspond to one of the one or more predicted sets of characters is substantially adjacent the virtual key of the multiple virtual keys corresponding to the last character of the sequential order of the one or more of the multiple characters of the first input. This feature is illustrated in FIG. 2 by having the new virtual keys 212 identified by the characters “1,” “2,” and “3” have locations substantially adjacent the “m” key, which, as noted above, is the last character of the first input “am.” In this manner, each of the new virtual keys 212 has a location that is based on the first input “am.” In some embodiments, substantially adjacent means not having any intervening objects or items between the two adjacent items. In other embodiments, substantially adjacent includes approximately near, as determined by one having reasonable skill in the art.

The example discussed above is one example where, for each of the one or more predicted sets of characters, the virtual key of the multiple virtual keys corresponding to the last character of the sequential order of the one or more of the multiple characters of the first input is closer to the respective new virtual key 212 than to the respective predicted set of characters displayed in the portion 206 of the touchscreen 202 that is different from the virtual keyboard 204. By having the new virtual keys 212 displayed in the virtual keyboard 204 and substantially adjacent the virtual key of the last character of the first input, the electronic device 200 may reduce the distance that a user would otherwise have to move his or her finger when selecting a predicted word or set of characters. Specifically, in this example, the user may only have to move his or her finger from the virtual “m” key to one of the new virtual keys 212 identified by the characters “1,” “2,” and “3” to select the predicted word instead of from the virtual “m” key to the portion 206 of the touchscreen 202 that is above the virtual keyboard 204. In providing the new virtual keys 212 closer to the virtual “m” key, selecting the predicted word may be more convenient, intuitive, and/or faster for a user to select, thereby increasing both the speed and accuracy with which a user can input text into an electronic device

As noted above, additional embodiments may include displaying, on the touchscreen 202, a respective symbol adjacent each of the one or more predicted sets of characters in the portion 206 of the touchscreen 202 that is different from the virtual keyboard 204. In this manner, each of the one or more new virtual keys 212 that each correspond to one of the one or more predicted sets of characters corresponds to one of the respective symbols. In some embodiments, each of the one or more new virtual keys 212 that correspond to one of the one or more predicted sets of characters are displayed in an order based on historical data of the user. For example, if the user tends to use the word “ample” more often than “amend” and “amend” more often than “ambulance,” the new virtual key 212 identified by the character “1” may appear first in the order of keys, from left to right, compared to the new virtual keys 212 identified by the characters “2” and “3.” In this manner, the user may select the most likely new virtual key 212 more quickly than the other new virtual keys 212, further increasing the text input speed of the user.

In additional embodiments, the method further includes reducing a size of the virtual key of the multiple virtual keys corresponding to the last character of the sequential order of the one or more of the multiple characters of the first input. In this manner, the location of each of the one or more new virtual keys 212 may include an area of the touchscreen 202 previously covered by the virtual key of the multiple virtual keys corresponding to the last character of the sequential order of the one or more of the multiple characters of the first input. As illustrated in FIG. 2, this feature may be included by reducing the size of the virtual “m” key so that the new virtual keys 212 identified by the characters “1,” “2,” and “3” may be placed above the reduced-size virtual “m” key and in the area previously covered by the full-size virtual “m” key. In this manner, the reduced size of the virtual “m” key may make the new virtual keys 212 identified by the characters “1,” “2,” and “3” more accessible to the user.

In yet further embodiments, the method of operating the electronic device 200 may include moving the virtual key of the multiple virtual keys corresponding to the last character of the sequential order of the one or more of the multiple characters of the first input. In this manner, the location of each of the one or more new virtual keys 212 may include an area of the touchscreen 202 previously covered by the virtual key of the multiple virtual keys corresponding to the last character of the sequential order of the one or more of the multiple characters of the first input. While not illustrated in FIG. 2, such embodiments are similar to the reduced-size virtual key, but are distinct in that the virtual key corresponding to the last character of the first input is moved to a different location on the touchscreen 202.

Once the one or more new virtual keys 212 are displayed on the touchscreen 202, the electronic device 200 can receive a second input, wherein, in some embodiments, the second input is the selection of one of the one or more new virtual keys 212. In such embodiments, each location of each of the one or more new virtual keys 212 that each correspond to one of the one or more predicted sets of characters may be one of multiple first locations. In this manner, the method of operating the electronic device 200 can include receiving, at a second location in the virtual keyboard 204 on the touchscreen 202, a second input of one of the one or more predicted sets of characters (block 312). In some embodiments, the second location may include the virtual key corresponding to the last character of the first input. In additional embodiments, the second location may include one of the virtual keys corresponding to the subsequent character generated by the processing circuit.

In some embodiments, the second input is received via a high-pressure touch indication, a long-duration touch indication, and/or a touch-and-drag indication. For example, with regard to the electronic device 200 illustrated in FIG. 2, a high-pressure touch indication may include a user pressing the virtual “m” key with a relatively high amount of force and/or pressure. Upon sensing such force and/or pressure, the electronic device 200 may magnify (i.e., increase the size of) and/or highlight at least one of the new virtual keys 212 for selection. By releasing the high-pressure touch indication during such magnifying and/or highlighting (i.e., by removing one's finger from the touchscreen 202), the user may select the desired new virtual key 212 for inputting the corresponding predicted word and/or set of characters. In other embodiments, a similar outcome may be achieved by a long-duration touch indication, which may include holding the virtual “m” key for a relatively longer period of time, wherein each of the new virtual keys 212 may correspond to a given period of time. In yet other embodiments, a touch-and-drag indication may be used, which may include touching the virtual key corresponding to the last character and dragging the user's finger in the direction, and to, the desired new virtual key 212. For example, with regard to FIG. 2, a user may press the virtual “m” key and move their finger to the new virtual key 212 identified by the character “1,” without removing their finger from the touchscreen 202, in order to select the predicted word “ample.” In other embodiments, the second input may include tapping, strike, swiping, speaking, and/or any other motion relevant to indicate a selection of one of the new virtual keys 212. Thus, in each of these embodiments, the electronic device 200 may receive a second input indicating a selection of one of the one or more predicted sets of characters at the virtual key corresponding to the last character of the sequential order of the first input.

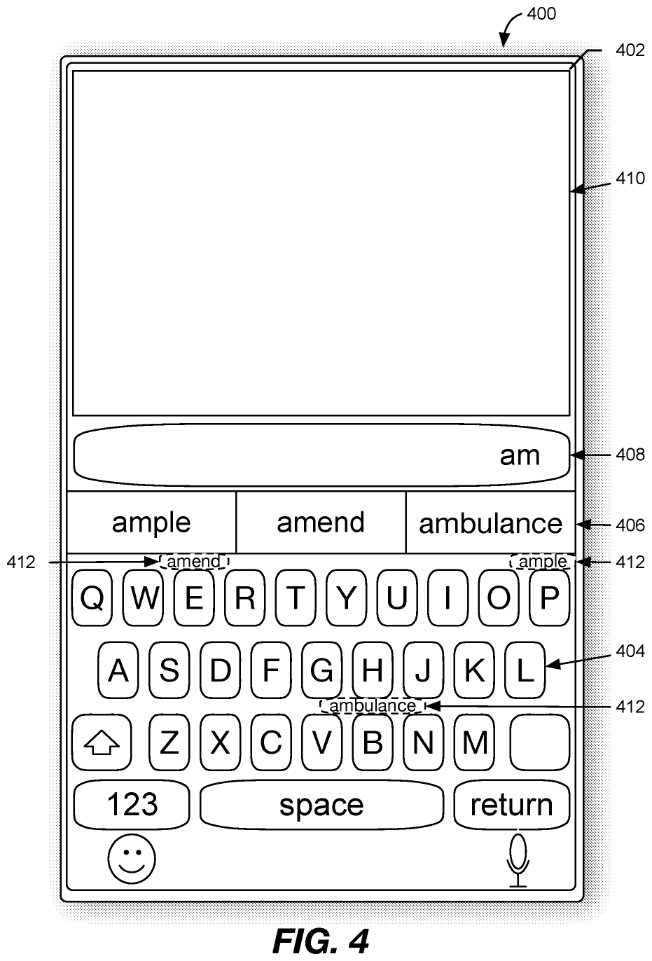

FIG. 4 illustrates other various embodiments of inventive concepts discussed herein. Specifically, FIG. 4 illustrates an electronic device 400 that includes a processing circuit, an interface connected to the processing circuit, and a touchscreen 402 connected to the interface, according to some examples. Similar to the electronic device 200 illustrated in FIG. 2, the electronic device 400 illustrated in FIG. 4 includes a virtual keyboard 404, a portion 406 of the touchscreen 402 above the virtual keyboard 404, an input field 408, and a display region 410. In contrast to the electronic device 200, the electronic device 400 includes one or more new virtual keys 412 (identified by the sets of characters “ample,” “amend,” and “ambulance”) in the virtual keyboard 404 that each correspond to a predicted set of characters (i.e., “ample,” “amend,” and “ambulance”) displayed in the portion 406 of the touchscreen 402 above the virtual keyboard 404.

In some embodiments, the one or more new virtual keys 412 are each substantially adjacent a virtual key corresponding to the respective subsequent character generated by the processing circuit. In this example, as noted above, the subsequent character for “ample” is the character “p,” the subsequent character for “amend” is the character “e,” and the subsequent character for “ambulance” is the character “b.” Thus, as illustrated in FIG. 4, the new virtual key 412 identified by the word “ample” is substantially adjacent the virtual “p” key, the new virtual key 412 identified by the word “amend” is substantially adjacent the virtual “e” key, and the new virtual key 412 identified by the word “ambulance” is substantially adjacent the virtual “b” key. In this regard, the location of each of the one or more new virtual keys 412 that each correspond to one of the one or more predicted sets of characters is substantially adjacent the virtual key of the multiple virtual keys corresponding to the respective subsequent character generated by the processing circuit. With regard to the illustrations of FIG. 4, as well as FIG. 2, in some embodiments, for each of the one or more predicted sets of characters, the one or more new virtual keys 412 each comprise the respective predicted set of characters. In this manner, the new virtual keys 412 may each be identified by the words “amend,” “ample,” and “ambulance,” respectively.

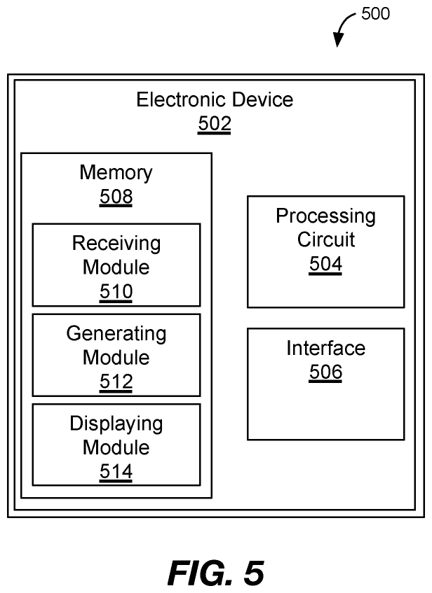

FIG. 5 illustrates components of electronic devices of some embodiments discussed herein. In this regard, FIG. 5 illustrates an electronic device 502, which may be the electronic device 200 and/or the electronic device 400. The electronic device 502 includes a processing circuit 504, an interface 506, and a memory 508. The memory 508 includes a receiving module 510, a generating module 512, and a displaying module 514. In some embodiments, the memory 508 may store instructions executable by the processing circuit 504 for performing aspects of the method(s) of operating the electronic device 502, as discussed above. In this regard, the receiving module 510 may include instructions for receiving, from a user, a first input of one or more of the multiple characters in a sequential order, as discussed in block 304 of FIG. 3. The generating module 512 may include instructions for generating one or more predicted sets of characters based on the first input, as discussed in block 306 of FIG. 3. Further, the displaying module 514 may include instructions associated with additional aspects discussed in FIG. 3. Specifically, the displaying module 514 may include instructions for displaying, on a touchscreen of the electronic device 500, a virtual keyboard including multiple virtual keys, wherein each of the multiple virtual keys corresponds to one character of multiple characters, as discussed in block 302 of FIG. 3. The displaying module 514 may also include instructions for displaying, on the touchscreen of the electronic device 500, each of the one or more predicted sets of characters in a portion of the touchscreen that is different from the virtual keyboard, as discussed in block 308 of FIG. 3. Further, the displaying module 514 may include instructions for displaying, on the touchscreen, one or more new virtual keys that each correspond to one of the one or more predicted sets of characters in the virtual keyboard, as discussed in block 310 of FIG. 3.

Although the various modules of the electronic device 500 in FIG. 5 are only discussed with regard to various aspects of FIG. 3, the modules are not limited only to such aspects. Rather, the various modules of the electronic device 500 may include instructions for performing any combination of aspects of operating the electronic device 500, as discussed herein.

In additional embodiments disclosed herein, any combination of aspects of operating the electronic device 500 may be stored in a computer program product including a tangible, non-transitory computer-readable storage medium including computer-readable program code that is executable by a processor to perform the aspects of the method.

### Further Definitions and Embodiments:

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method of operating an electronic device comprising a processing circuit, an interface connected to the processing circuit, and a touchscreen connected to the interface, the method comprising:
displaying, on the touchscreen, a virtual keyboard comprising a plurality of virtual keys, wherein each of the plurality of virtual keys corresponds to one character of a plurality of characters;
receiving, via the interface and from a user, a first input of one or more of the plurality of characters in a sequential order;
generating one or more predicted sets of characters based on the first input, wherein each of the one or more predicted sets of characters comprises a last character of the sequential order of the one or more of the plurality of characters of the first input and a subsequent character generated by the processing circuit;
displaying, on the touchscreen, each of the one or more predicted sets of characters in a portion of the touchscreen that is different from the virtual keyboard; and
displaying, on the touchscreen, one or more new virtual keys that each correspond to one of the one or more predicted sets of characters in the virtual keyboard, wherein each of the one or more new virtual keys that each correspond to one of the one or more predicted sets of characters has a location that is based on the first input.

2. The method of claim 1, wherein, for each of the one or more predicted sets of characters, the virtual key of the plurality of virtual keys corresponding to the last character of the sequential order of the one or more of the plurality of characters of the first input is closer to the new virtual key than to the respective predicted set of characters displayed in the portion of the touchscreen that is different from the virtual keyboard.

3. The method of claim 2, wherein the location of each of the one or more new virtual keys that each correspond to one of the one or more predicted sets of characters is substantially adjacent the virtual key of the plurality of virtual keys corresponding to the last character of the sequential order of the one or more of the plurality of characters of the first input.

4. The method of claim 3, further comprising:
displaying, on the touchscreen, a respective symbol adjacent each of the one or more predicted sets of characters in the portion of the touchscreen that is different from the virtual keyboard, wherein each of the one or more new virtual keys that each correspond to one of the one or more predicted sets of characters corresponds to one of the respective symbols.

5. The method of claim 3, wherein each location of each of the one or more new virtual keys that each correspond to one of the one or more predicted sets of characters is one of a plurality of first locations, the method further comprising:
receiving, at a second location in the virtual keyboard on the touchscreen, a second input of one of the one or more predicted sets of characters, wherein the second input is received via a high-pressure touch indication, a long-duration touch indication, and/or a touch-and-drag indication.

6. The method of claim 2, further comprising:
reducing a size of the virtual key of the plurality of virtual keys corresponding to the last character of the sequential order of the one or more of the plurality of characters of the first input, wherein the location of each of the one or more new virtual keys that each correspond to one of the one or more predicted sets of characters is substantially adjacent the virtual key of the plurality of virtual keys corresponding to the last character of the sequential order of the one or more of the plurality of characters of the first input and at an area of the touchscreen previously covered by the virtual key of the plurality of virtual keys corresponding to the last character of the sequential order of the one or more of the plurality of characters of the first input.

7. The method of claim 2, further comprising:
moving the virtual key of the plurality of virtual keys corresponding to the last character of the sequential order of the one or more of the plurality of characters of the first input, wherein the location of each of the one or more new virtual keys that each correspond to one of the one or more predicted sets of characters is substantially adjacent the virtual key of the plurality of virtual keys corresponding to the last character of the sequential order of the one or more of the plurality of characters of the first input and at an area of the touchscreen previously covered by the virtual key of the plurality of virtual keys corresponding to the last character of the sequential order of the one or more of the plurality of characters of the first input.

8. The method of claim 2, wherein the location of each of the one or more new virtual keys that each correspond to one of the one or more predicted sets of characters is substantially adjacent the virtual key of the plurality of virtual keys corresponding to the respective subsequent character generated by the processing circuit.

9. The method of claim 8, wherein each location of each of the one or more new virtual keys that each correspond to one of the one or more predicted sets of characters is one of a plurality of first locations, the method further comprising:
receiving, at a second location in the virtual keyboard on the touchscreen, a second input of one of the one or more predicted sets of characters, wherein the second input is received via a high-pressure touch indication, a long-duration touch indication, and/or a touch-and-drag indication.

10. The method of claim 8, wherein, for each of the one or more predicted sets of characters, the one or more new virtual keys each comprise the respective predicted set of characters.

11. The method of claim 1, wherein the location of each of the one or more new virtual keys that each correspond to one of the one or more predicted sets of characters is substantially adjacent the virtual key of the plurality of virtual keys corresponding to the last character of the sequential order of the one or more of the plurality of characters of the first input.

12. The method of claim 1, wherein the location of each of the one or more new virtual keys that each correspond to one of the one or more predicted sets of characters is substantially adjacent the virtual key of the plurality of virtual keys corresponding to the respective subsequent character generated by the processing circuit.

13. The method of claim 1, further comprising:
displaying, on the touchscreen, a respective symbol adjacent each of the one or more predicted sets of characters in the portion of the touchscreen that is different from the virtual keyboard, wherein each of the one or more new virtual keys that each correspond to one of the one or more predicted sets of characters corresponds to one of the respective symbols.

14. The method of claim 13, wherein each of the one or more new virtual keys that each correspond to one of the one or more predicted sets of characters are displayed in an order based on historical data of the user.

15. The method of claim 1, wherein, for each of the one or more predicted sets of characters, the one or more new virtual keys each comprise the respective predicted set of characters.

16. The method of claim 1, further comprising:
receiving, at the virtual key of the plurality of virtual keys corresponding to the last character of the sequential order of the one or more of the plurality of characters of the first input, a second input indicating a selection of one of the one or more predicted sets of characters, wherein the second input is received via a high-pressure touch indication, a long-duration touch indication, and/or a touch-and-drag indication.

17. The method of claim 1, further comprising:
receiving a second input indicating a selection of one of the one or more predicted sets of characters, wherein the second input is received at the virtual key of the plurality of virtual keys corresponding to the respective subsequent character generated by the processing circuit and via a high-pressure touch indication, a long-duration touch indication, and/or a touch-and-drag indication.

18. The method of claim 1, wherein each of the one or more predicted sets of characters is a word containing one of the one or more of the plurality of characters of the first input.

19. The method of claim 1, wherein each of the one or more predicted sets of characters in the portion of the touchscreen different from the virtual keyboard are selectable by the user.

20. A computer program product comprising:
a tangible, non-transitory computer-readable storage medium comprising computer-readable program code that is executable by a processor to perform:
displaying, on a touchscreen of an electronic device, a virtual keyboard comprising a plurality of virtual keys, wherein each of the plurality of virtual keys corresponds to one character of a plurality of characters;
receiving, via an interface of the electronic device and from a user, a first input of one or more of the plurality of characters in a sequential order;
generating one or more predicted sets of characters based on the first input, wherein each of the one or more predicted sets of characters comprises a last character of the sequential order of the one or more of the plurality of characters of the first input and a subsequent character generated by a processing circuit of the electronic device;
displaying, on the touchscreen, each of the one or more predicted sets of characters in a portion of the touchscreen that is different from the virtual keyboard; and
displaying, on the touchscreen, one or more new virtual keys that each correspond to one of the one or more predicted sets of characters in the virtual keyboard, wherein each of the one or more new virtual keys that each correspond to one of the one or more predicted sets of characters has a location that is based on the first input.
